(19) United States
(12) Patent Application Publication
(10) Pub. No.: US 2010/0094732 A1
(43) Pub. Date: Apr. 15, 2010

(54) Systems and Methods to Verify Payment Transactions

(75) Inventor: Glyn Barry SMITH, Chesterfield (GB)

Correspondence Address: GREENBERG TRAURIG, LLP (SV);IP DOCKETING, 2450 COLORADO AVENUE, SUITE 400E, SANTA MONICA, CA, 90404, US

(73) Assignee: VIDICOM LIMITED, Chesterfield (GB)

(21) Appl. No.: 12/369,649

(22) Filed: Feb. 11, 2009

(30) Foreign Application Priority Data
Feb. 12, 2008 (GB) 0802555.3

(51) Int. Cl. G06Q 20/00; G06Q 10/00; H04W 4/12

(52) U.S. Cl. 705/30; 705/44; 455/466

(57) ABSTRACT

An apparatus includes a processor, storage, memory and a network connection. The processor is configured to: store user details in the storage including a plurality of telephone numbers, each associated with details of a payment card; receive, via the network connection, a request including a first telephone number related to a transaction; identify payment card details based on the first telephone number in response to the request; obtain an indication as to whether the transaction is valid using the first telephone number; and send the payment card details via the network connection to a payment server to process the request if the transaction is determined to be valid.

### RELATED APPLICATIONS

The present application claims priority to United Kingdom Patent Application Number 08 02 555.3, filed on Feb. 12, 2008 and entitled “Verifying Payment Transactions,” the disclosure of which is incorporated herein by reference.

### FIELD OF THE TECHNOLOGY

At least some embodiments of the disclosure relate to apparatus for verifying a payment transaction, particularly payments by credit or debit card.

### BACKGROUND

In recent times, payment for goods and services by use of a credit or debit card has become extremely popular. Payment in person using a “chip and pin” card, where a card includes a chip that is difficult to forge and the cardholder is required to input a personal identification number (PIN), is considered to be reasonably secure. However, transactions where the cardholder is not present, such as where a card is used over the telephone or on the Internet, are considered inherently insecure. In these transactions the user is required to enter a card number, an expiry date and a security code. A third party having these details can use them to make purchases and can run up very large bills before the cardholder becomes aware that this is happening. This has several detrimental effects. The payments must be honored either by the cardholder or by the issuing bank, the card in question must be stopped and a new one issued, and at worst, the payments may be for items to be used in criminal activities and there is no way to trace the actual purchaser.

This type of credit and debit card fraud is known as identity theft and is an increasing problem. With no way to check a cardholder's identity, currently the only way for a cardholder to prevent identity theft is never to use the card when not present to enter the PIN.

### SUMMARY OF THE DESCRIPTION

According to a first aspect, there is provided an apparatus for verifying a payment transaction, including a processor, storage, memory and a network connection, where the processor is configured to store user details in the storage including a plurality of transaction identifications, receive, via the network connection, a verification request including a first transaction identification, identify contact details in response to the verification request, using the contact details, obtain an indication as to whether the transaction is valid, and return the indication via the network connection to the issuer of the verification request.

According to a second aspect, there is provided an apparatus for completing a payment transaction, including a processor, storage, memory and a network connection, where the processor is configured to store user details in the storage including a plurality of telephone numbers, each associated with details of a payment card, receive, via the network connection, a verification request including a first telephone number, identify payment card details in response to the verification request, using the telephone number, obtain an indication as to whether the transaction is valid, and if the transaction is valid, send the payment card details via the network connection to a payment server, and if the transaction is not valid return an indication via the network connection to the issuer of the verification request.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows an environment in which at least one embodiment may be implemented.

FIG. 2 shows a computer system shown in FIG. 1.

FIG. 3 shows a user shown in FIG. 2 receiving a validation message on a mobile device shown in FIG. 1.

FIG. 4 illustrates the verification of a purchase according to one embodiment.

FIG. 5 is a telephony diagram of a first embodiment.

FIG. 6 is a telephony diagram of a second embodiment.

FIG. 7 illustrates a database stored on a server shown in FIG. 1.

FIG. 8 details operations carried out by a server shown in FIG. 1 to verify a transaction.

FIG. 9 details operations carried out during FIG. 8 to verify a transaction using a first method.

FIG. 10 details operations carried out during FIG. 8 to verify a transaction using a second method.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

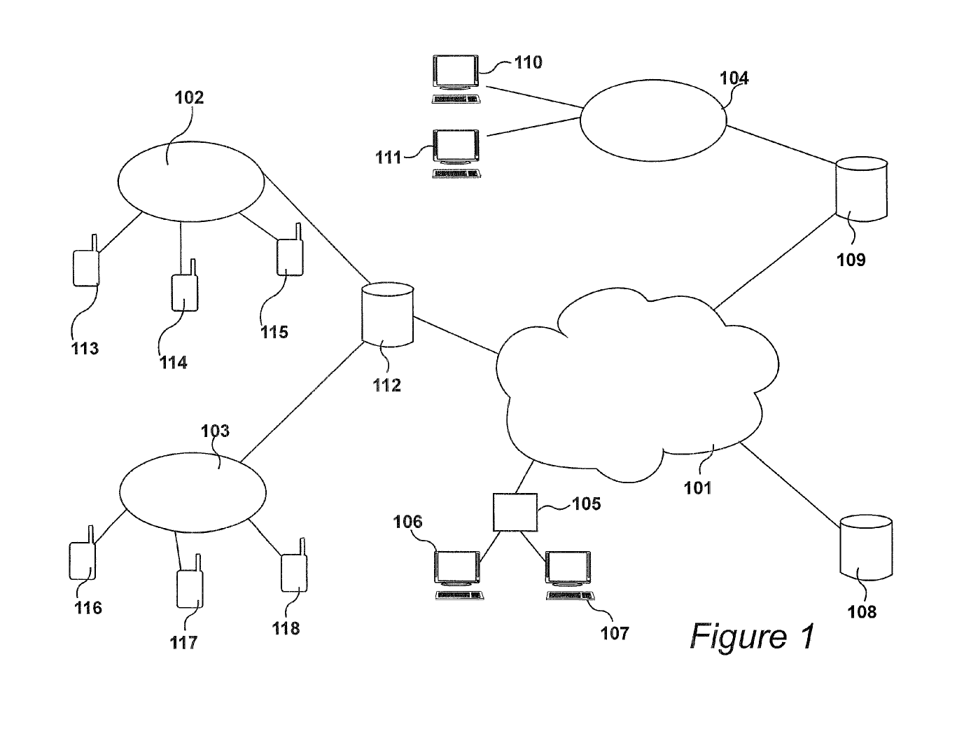

FIG. 1 shows an environment in which at least one embodiment may be implemented. The environment shown in FIG. 1 includes the Internet 101, mobile telephony networks 102 and 103 and a landline telephony network 104. An Internet Service Provider (ISP) 105 provides connection to the Internet 101 for computers 106 and 107. Also connected to the Internet are at least one merchant server 108, which hosts an e-commerce website on which a user may purchase goods and services, and at least one bank server 109 which holds information regarding users' payment cards, such as credit or debit cards.

The bank server 109 is also connected to the landline telephony network 104, to which merchant computers 110 and 111 are also connected. Merchant computers 110 and 111 are computers in premises such as shops or any other place where payment may be taken for goods and services using a card-payment machine. Generally, card-payment machines can also be used when the cardholder is not present, such as when taking orders by telephone, and these machines communicate with the bank server 109 via the landline telephony network 104.

The bank server 109 may receive card payment requests, which are requests for payments to be made using credit or debit cards, either via the Internet from the Internet merchant server 108 or via the landline telephony network 104 from one of the merchant computers 110 or 111. These requests are made using established and secure protocols. If the card details received in such a request relate to a valid payment card on an account that has sufficient funds or credit then the bank server 109 will authorize the payment.

Also connected to the Internet 101 is a verification server 112 which is in turn connected to the mobile telephony networks 102 and 103. These networks provide communication interfaces for mobile devices 113, 114, 115, and 116, 117 and 118 respectively. These may be mobile telephones, personal digital assistants, or other mobile devices capable of receiving messages via a mobile telephony network. The verification server provides an additional level of security in “cardholder not present” transactions. Upon receipt of a card payment request, the bank server 109 issues a verification request to verification server 112, which contacts a relevant mobile device and receives confirmation from the cardholder that they are indeed making a purchase. Should this confirmation not be received, then the card payment is declined.

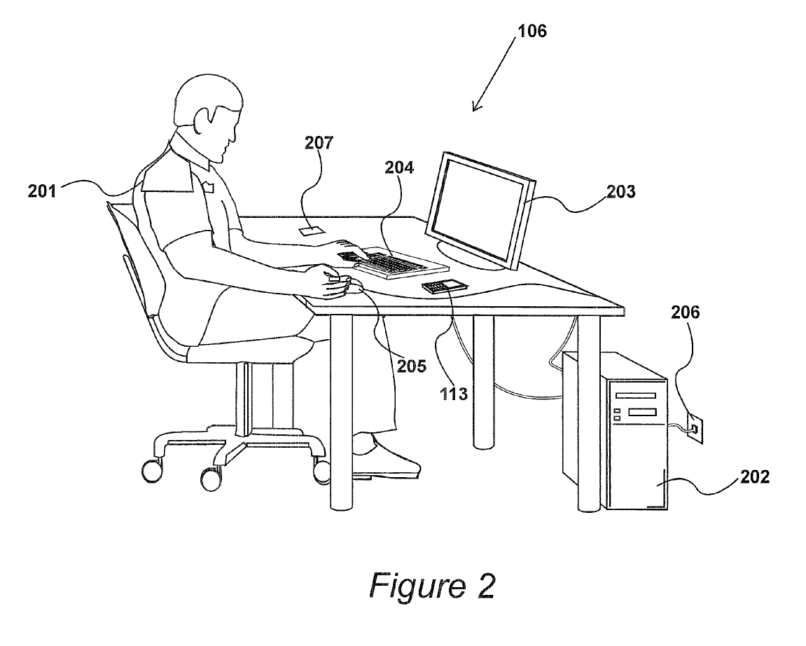

FIG. 2 shows a computer system shown in FIG. 1. In FIG. 2, a computer user 201 uses a computer system 106 to make a purchase over the Internet 101. The computer system 106 may include a computer 202, a monitor 203, a keyboard 204 and, a mouse 205. The computer 202 is connected to the Internet 101 via a telephone line 206, although many methods of connecting a computing system to the Internet are known and can be used. The user 201 browsers to a website, displayed on the monitor 203, and using the keyboard 204 and the mouse 205 selects an item for purchase and inputs the details of his payment card 207. Although the user may be reassured by the knowledge that the communication between his computer, the site he is purchasing from and his bank is secure, he has no way of knowing whether or not a person administering the website is storing his card details for fraudulent use. For this reason, he has registered his details with the verification server 112.

After he has completed and sent the payment details he receives an SMS on his mobile device 113, which in this example is a mobile telephone, asking him for authorization of the payment. He replies to the SMS by sending back another SMS including a PIN known only to him, and his payment is then accepted.

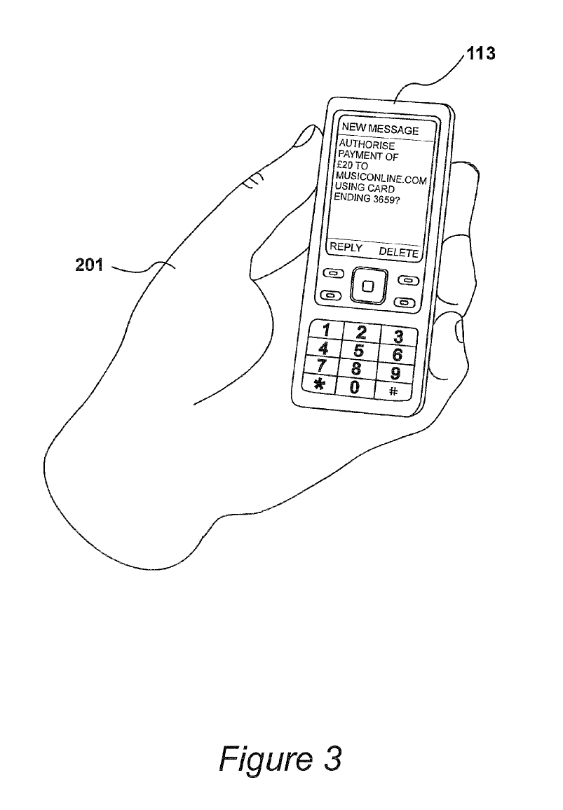

FIG. 3 shows a user shown in FIG. 2 receiving a validation message on a mobile device shown in FIG. 1. In FIG. 3, the user 201 receives an SMS on his mobile telephone 113. The message asks whether he wishes to authorize a payment of a specific amount to a specific merchant using a card identified only by its last four digits. If the user is indeed making this purchase then he can reply by sending an SMS in return containing his PIN, and the payment will be authorized. However, if at any time the user receives a message such as this but is not attempting to make a payment, he can ensure that the payment is declined either by not replying to the SMS, replying without the valid PIN, or by sending back a specified word, such as “NO.” He is by this means alerted that a third party has his card details and can immediately contact his bank to stop the card. It may even be possible, given the speed with which the fraud will have been noticed, that the person attempting to make the payment is traceable.

Thus the user 201 can give out his card details secure in the knowledge that if an unscrupulous person does store and attempt to use them, the worst inconvenience he will face is the necessity to get a new card. As long as he keeps his PIN secret, even a person who stole both his credit card and his mobile phone would not be able to make fraudulent payments.

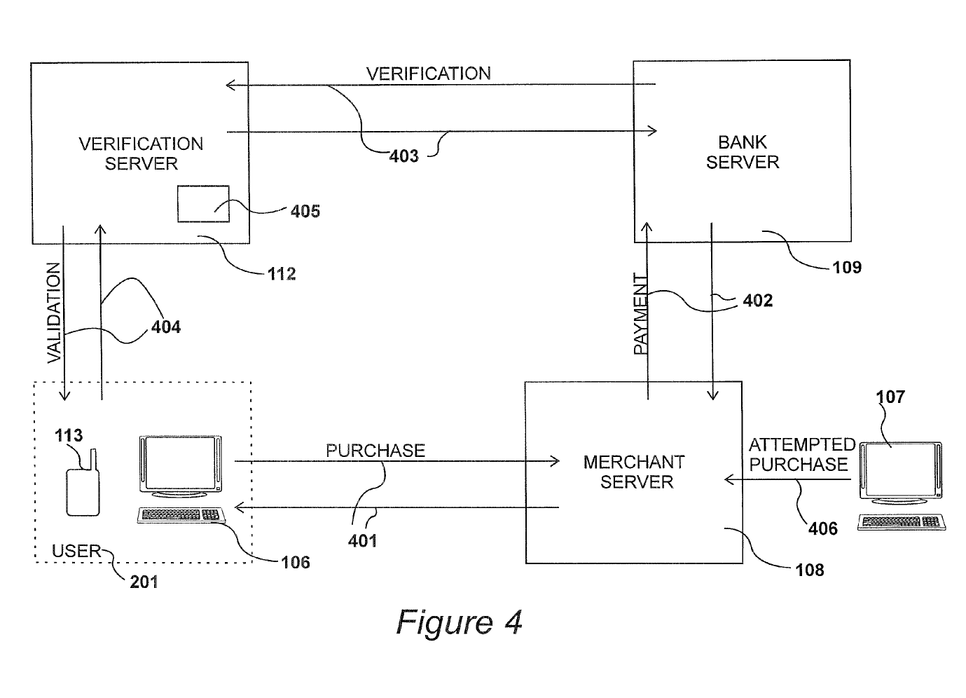

FIG. 4 illustrates the verification of a purchase according to one embodiment. In FIG. 4, the user 201 has a computing system 106 and a mobile telephone 113. Using one of these he attempts to make a purchase 401 from the merchant server 108 with payment to be made by a specified payment card. The merchant server 108 requests payment 402 from a bank server 109. The bank server 109 requests verification 403 of the cardholder's identity from a verification server 112. Verification server 112 accesses its database 405 and requests the validation 404 of the purchase from user 201, via the mobile telephone 113. The user validates the purchase to the verification server 112, which verifies the cardholder's identity to the bank server 109, which authorizes the payment to the merchant server 108, which completes the purchase.

However, should an attempted purchase 406 be made from a computer system 107 using the user's payment card details, then the user 201 will not validate it, and the attempted purchase will not succeed.

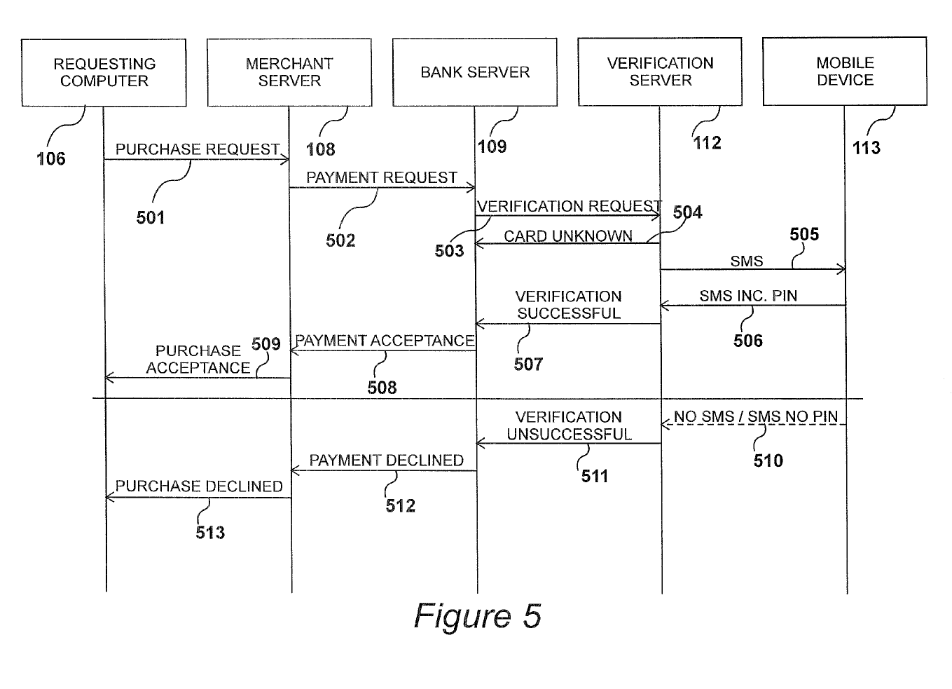

FIG. 5 is a telephony diagram of a first embodiment. Operations performed within the environment within FIG. 1 are detailed in FIG. 5. A telephony diagram is illustrated, showing communications between the requesting computer 106, a merchant server 108, a bank server 109, a verification server 112 and a mobile device 113.

As previously described, the merchant server 108 receives a purchase request 501 via Internet 101 from the requesting computer 106. This request includes details of a payment card. The merchant server 108 then sends a payment request 502 to the bank server 109 over a secure connection, indicating the card details and the amount to be debited. The bank server 109 sends a verification request 503 to the verification server 112. This request includes a transaction identification, which in this embodiment is the card number. It also includes the identification of the merchant server 108 and the amount to be debited.

The verification server 112 identifies whether this card number is stored in its database. If not, then verification server 112 sends an message 504 indicating this to bank server 109, which then authorizes or declines the payment in the normal way. However, if the card member is found then the verification server 112 identifies contact details by retrieving a telephone number associated with the card number, which in this example is the telephone number of the mobile device 113. It then sends an SMS 505 to the telephone number identifying the merchant, the amount to be debited and the payment card number, preferably using only a portion of the card number. The user of mobile device 113 will then either reply to the SMS 506 or not reply.

If the user returns the SMS 506 including a correct PIN, then the verification server 112 returns an indication 507 to the bank server 109 that the transaction has been verified, and on receipt of this, assuming that the account has sufficient funds, the bank server sends a payment acceptance indication 508 to the merchant server 108 which then confirms the purchase to requesting computer 106 at 509. If there are not sufficient funds in the user's account then of course the payment will be declined by the bank server 109. However, the bank server 109 will still request verification because if it is a fraudulent payment request the user will need to know this.

If the mobile device 113 returns an SMS 510 that includes no PIN or a wrong PIN, or sends no reply at all, then the verification server will send an indication 511 to the bank server 109 that the verification is unsuccessful. The bank server 109 will then decline the payment at 512 to the merchant server 108, which will then indicate at 513 to the requesting computer that the purchase cannot be made because the cardholder's identity could not be verified.

The verification server 112 can also be used to verify card payments made by telephone. In this case, the merchant server 108 may be replaced by one of merchant computers 110 and 111, and the requesting computer 106 is replaced by the user 201. The communication of purchase request 501 and the acceptance 509 or declining 513 of the purchase occur by telephone to an operator who enters the details into the merchant computer and then requests payment from the bank server 109.

Since the user's card details are only sent over secure connections, and since the verification server 112 stores only the card number and not the additional details such as expiry date, name or security code usually necessary to make a card payment, this system effectively prevents credit card fraud without opening up any possibilities for further fraud.

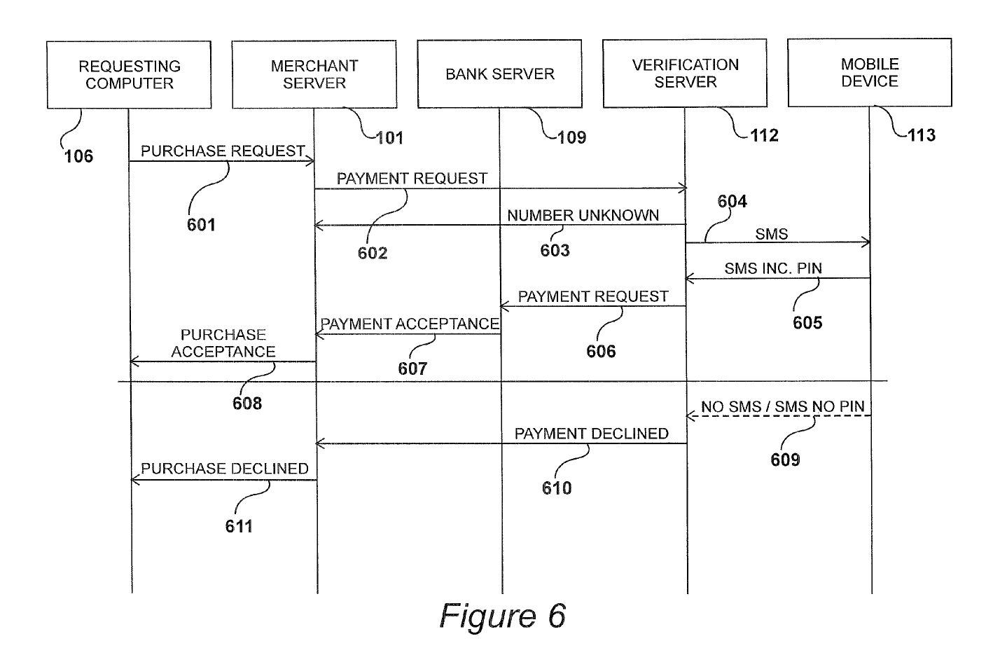

FIG. 6 is a telephony diagram of a second embodiment of the invention. In FIG. 6, the verification server 112 can take on a more active role in the payment process. Although the system described herein alerts the user to a fraudulent use of his credit card, he may wish to avoid giving out his card details at all. In this case, his card details may be stored on the verification server 112. In this case, instead of entering credit card details, he may, on a merchant website that permits it, enter simply his telephone number. The telephony diagram illustrated in FIG. 6 shows communications between the requesting computer 106, the merchant server 108, the bank server 109, the verification server 112 and the mobile device 113 in this alternative embodiment.

In FIG. 6, the requesting computer 106 makes a purchase request 601 to the merchant server. This does not include any credit card details but only a mobile telephone number. The merchant server 108 then sends a verification and payment request 602 to verification server 112, the request including a transaction identification that in this embodiment is the telephone number. The verification server 112 identifies contact details in response to the verification request 602 by interrogating its database 405 to find this telephone number. If it is not found then the verification server 112 sends an indication 603 of this back to the merchant server 108. However, if it is found then verification server sends an SMS 604 to the telephone number, which is the number of the mobile device 113, asking if the user wishes to make the payment.

If the user replies with an SMS 605 including a correct PIN then the verification server transmits a payment request 606 to the bank server 109. This request includes details of the merchant received in payment request 602, and stored card details. The bank server 109 processes this request and sends the payment acceptance message 607 to merchant server 109, which sends a purchase acceptance message 608 to requesting computer 106. Alternatively, if the user's account does not have sufficient funds the bank server 109 will decline the request.

If the user does not reply to the SMS 604 or replies with an SMS 609 containing an incorrect or no PIN, then the verification server 112 sends an indication 610 to the merchant server 108 that the payment has been declined and the merchant server declines the purchase to requesting computer 106 at 611.

Thus in this embodiment the user places trust in verification server 112 by depositing card details with it, but no longer has to enter card details into websites, which also saves time.

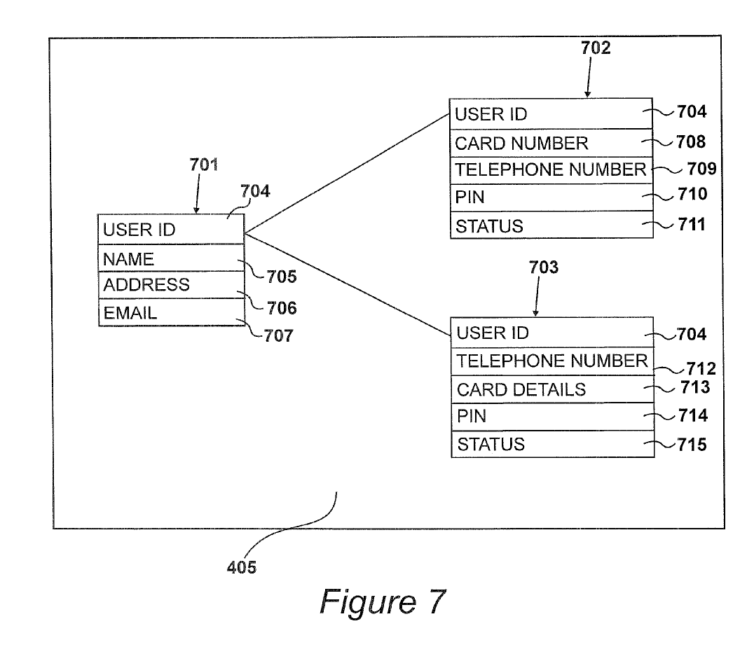

FIG. 7 illustrates a database stored on a server shown in FIG. 1. In FIG. 7, the database 405 is stored on the verification server 112. It includes three tables, a user details table 701, a first payment cards table 702 and a second payment cards table 703. When a user registers with the verification server 112, they are given a unique user ID 704, and they give their name 705 and other details such as their address 706 and email 707. It is not strictly necessary for their name, address or email to be submitted, but these details may be helpful in preventing fraud.

To take advantage of the first embodiment shown in FIGS. 4 and 5, the user gives at least one card number and associated telephone number. Thus first payment cards table 702 includes, for each record, a user ID 704, a card number 708, a telephone number 709, a PIN 710 and a status 711, which may be used to indicate when a card is potentially being used fraudulently. Thus the user can associate a different telephone number with each card number on the account. For each card, the PIN 710 is randomly generated and sent to the user by post (mail), and it is checked that the address they have submitted is the same as the billing address on the payment card. By requiring that the PIN is sent only to the billing address it is ensured that a person cannot register a stolen credit card. Ideally, a different PIN is used for each payment card, or for each payment card that is associated with a different telephone number, but this may not in practice be possible. Other types of password may be used instead of a PIN, but a numeric password is easiest to enter using a numeric keypad such as on a mobile telephone.

Should the user wish to take advantage of the second embodiment of the invention shown in FIG. 6, then details are entered into a second payment cards table 703. Each record includes the user ID 704, telephone number 712, card details 713, a PIN 714 and status 715. The card details 713 include all the card details such as start date, expiry date, issue number and security code, as well as the card number that is included in the first payment cards database 702.

The database 405 is only an example of the way in which this type of data may be stored. Any method of storing and associating card numbers and telephone numbers may be used.

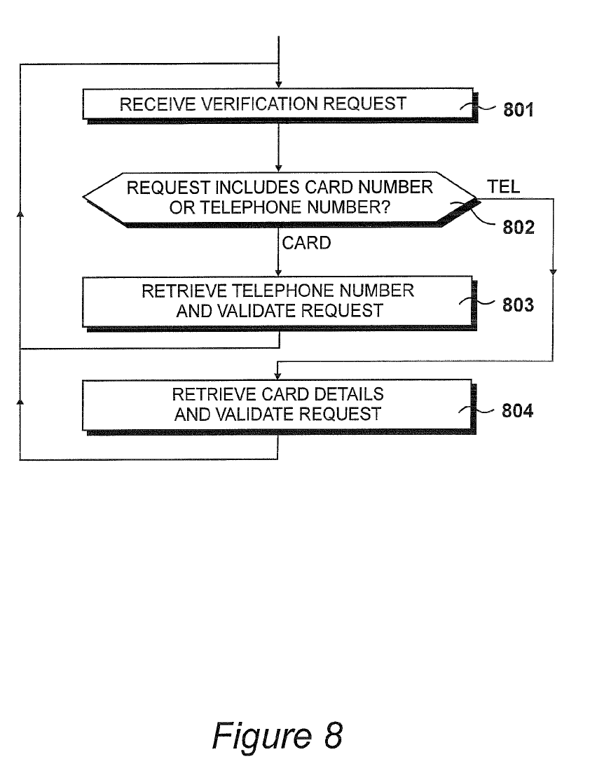

FIG. 8 details operations carried out by a server shown in FIG. 1 to verify a transaction. In FIG. 8, the verification server 112 carries out operations to verify a cardholder's identity. In operation 801 a verification request is received and in operation 802 a question is asked as to whether the included transaction identifier is a card number or a telephone number. If it is a card number, then in operation 803 associated contact details are retrieved and the request is validated. If the answer to the question asked in operation 802 is that it is a telephone number, then in operation 804 the associated card details are retrieved and the request is validated.

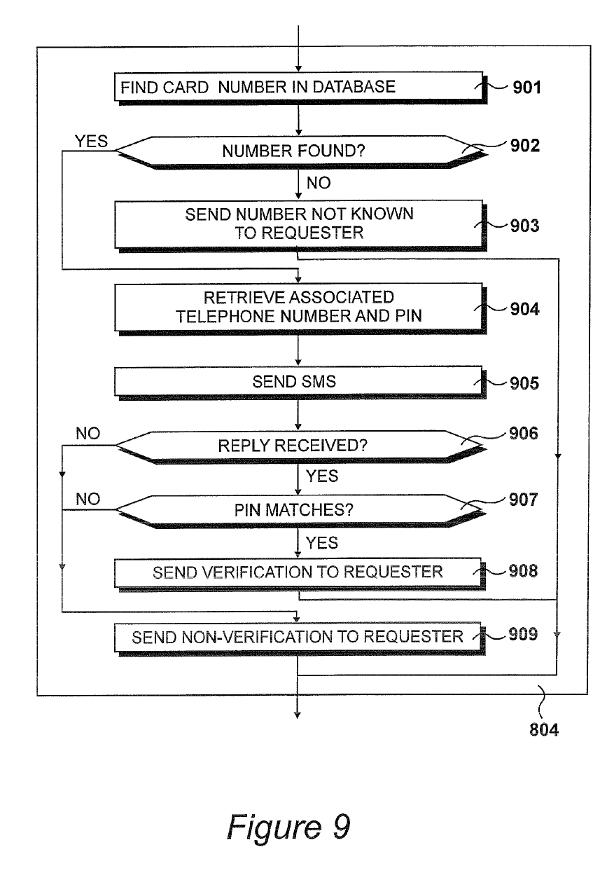

FIG. 9 details operations carried out during FIG. 8 to verify a transaction using a first method. FIG. 9 details the operation 803 at which the telephone number is received and the request is validated. In operation 901 the received card number is searched for in database 405, and in operation 902 a question is asked as to whether the card number has been found. If this question is answered in the negative then in operation 903 an indication that the card number is not in the database is sent back to the requesting bank server. If it is found, however, then in operation 904 the telephone number and PIN associated with it are retrieved. In operation 905 an SMS is sent to this telephone number and in operation 906 a question is asked as to whether a reply has been received. If this question is answered in the affirmative then in operation 907 a further question is asked as to whether the PIN matches the retrieved PIN. If this question is also answered in the affirmative then in operation 908 a verification is sent to the issuer of the validation request. However if either of the questions asked in operations 906 and 907 are answered in the negative, then an indication that the verification was not successful is sent to the requester in operation 909.

Variations on this are possible. For example, if an incorrect PIN is received a user may be given another chance to enter a correct PIN. There may be specified words that the user can reply with if he is not making the indicated payment, which will for example start a process on verification server 112 to refuse all requests for that card. Further, communication with the mobile device 113 does not have to be by SMS. Other methods of sending a message over a mobile telephony network could be used.

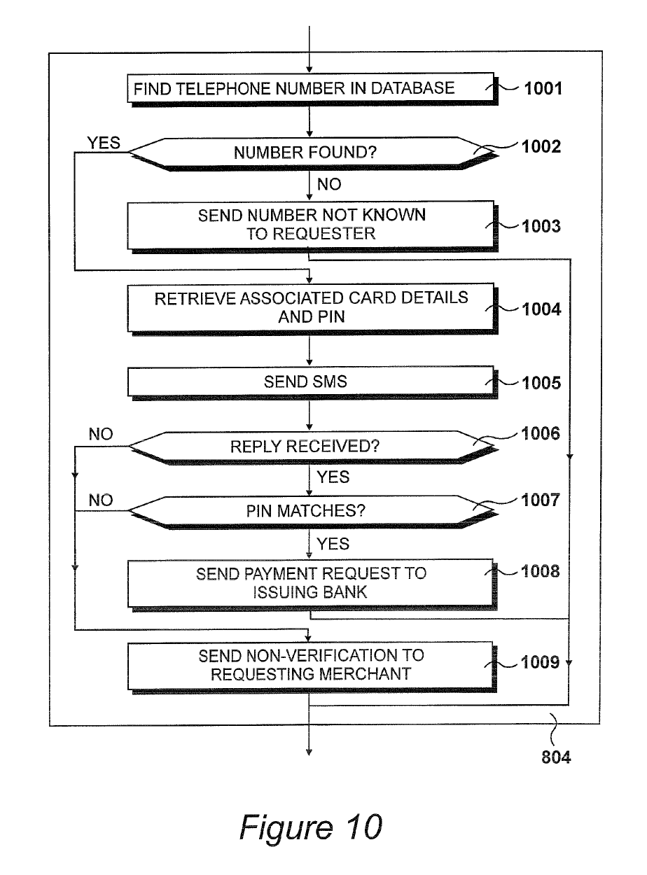

FIG. 10 details operations carried out during FIG. 8 to verify a transaction using a second method. FIG. 10 details the operation 804 at which the verification server 112 validates the payment and sends card details to make the payment. In operation 1001 the received telephone number is searched for in the database 405 and in operation 1002 a question is asked as to whether the telephone number has been found. If this question is answered in the negative then in operation 1003 an indication that the telephone number is not in the database is sent back to the requesting merchant server. If it is found, however, then in operation 1004 the card details and PIN associated with it are retrieved. In operation 1005 an SMS is sent and in operation 1006 a question is asked as to whether a reply has been received. If this question is answered in the affirmative then a further question is asked in operation 1007 as to whether the PIN matches the one received. If this question is also answered in the affirmative then in operation 1008 the card details are sent as a payment request to the issuing bank of the identified card. However, if either of the questions is answered in the negative then an indication of non-verification is sent to the requesting merchant.

Again, variations on this process are possible, such as communication by other means than SMS.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. An apparatus, comprising
a processor;
storage;
memory; and
a network connection, wherein the processor is configured to:
store user details in the storage including a plurality of telephone numbers, each associated with details of a payment card;
receive, via the network connection, a request including a first telephone number related to a transaction;
identify payment card details based on the first telephone number, in response to the request;
obtain an indication as to whether the transaction is valid using the first telephone number; and
send the payment card details via the network connection to a payment server to process the request if the transaction is determined to be valid.

2. The apparatus of claim 1, wherein the processor is configured to obtain an indication as to whether the transaction is valid by:
sending a message to the first telephone number; and
determining whether a valid reply to the message has been received from the first telephone number.

3. The apparatus of claim 2, wherein the message is sent via Short Message Service (SMS) and the valid reply is received via SMS.

4. The apparatus of claim 2, wherein the user details include a stored password associated with each of the telephone numbers, and the processor is configured to determine whether a valid reply has been received by:
receiving a reply including a received password;
retrieving a first stored password associated with the first telephone number; and
comparing the received password with the first stored password.

5. The apparatus of claim 4, wherein if no reply has been received within a specified period of time, the transaction is considered to be invalid.

6. The apparatus of claim 1, wherein the identifying the payment card details comprises:
searching the user details to find the first telephone number; and
retrieving details of a payment card associated with the first telephone number.

7. The apparatus of claim 1, wherein the processor is further configured to:
receive a request to set up a user account;
store new user details including contact details and an identification of at least one payment card;
generate a password and store the password in the new user details; and
obtain a postal address associated with the at least one payment card to send the password.

8. The apparatus of claim 1, wherein the processor is configured to return an indication via the network connection to an issuer of the request if the transaction is determined to be not valid.

9. A method, comprising:
receiving, by a processor, a request from a network-connected device, the request including an identification of a telephone number;
retrieving, by the processor from storage coupled to the processor, stored payment card details based on the telephone number;
sending a message to the telephone number;
determining, by the processor, whether a valid reply to the message has been received from the telephone number; and
sending, by the processor, the payment card details to a payment server to process the request in response to the valid reply to the message.

10. The method of claim 9, wherein the message is sent to the telephone number via Short Message Service (SMS).

11. The method of claim 10, wherein the valid reply is received from the telephone number via SMS.

12. The method of claim 10, further comprising identifying a stored password associated with the telephone number, and the determining whether a valid reply has been received comprises:
receiving a reply including a received password; and
comparing the received password with the stored password.

13. The method of claim 10, wherein if no reply has been received within a specified period of time, the payment card details is not sent to the payment server.

14. The method of claim 9, wherein the retrieving the stored payment card details comprises:
interrogating stored data to find the telephone number; and
retrieving a payment card identification associated with the telephone number.

15. The method of claim 9, wherein the payment card details comprise an identification of a payment card.

16. The method of claim 9, wherein the network-connected device is a server at which a user makes a purchase.

17. The method of claim 9, further comprising:
receiving a request to set up a user account;
storing an identification of at least one payment card in the user account;
storing contact details and associating the contact details with the identification of the payment card;
generating and storing a password and associating the password with the payment card; and
obtaining a postal address associated with the payment card to send the password.

18. The method of claim 17, wherein the contact details include a telephone number of a mobile phone.

19. The method of claim 9, wherein the message is sent to a mobile device at the telephone number.

20. A computer-readable medium having computer-readable instructions executable by a computer such that, when executing the instructions, the computer will perform a method comprising:
receiving a request from a network-connected device, the request including an identification of a telephone number;
retrieving stored payment card details based on the telephone number;
sending a message to the telephone number;
determining whether a valid reply to the message has been received from the telephone number; and
sending the payment card details to a payment server to process the request in response to the valid reply to the message.
